(19) United States
(12) Patent Application Publication
(10) Pub. No.: US 2004/0064946 A1
(43) Pub. Date: Apr. 8, 2004

(54) Tube to header joint using a non-metallic header

(76) Inventors: Geoff Smith, Jackson, TN (US); Jay Korth, Kenosha, WI (US)

Correspondence Address: JAMES RAY & ASSOCIATES, 2640 Pitcairn Road, Monroeville, PA, 15146, US

(21) Appl. No.: 10/610,937

(22) Filed: Jun. 30, 2003

Related U.S. Application Data
(60) Provisional application No. 60/392,994, filed on Jun. 28, 2002.

(51) Int. Cl. B23P 15/26

(52) U.S. Cl. 29/890.043

(57) ABSTRACT

The present invention provides a method of reducing weight when securing a predetermined plurality of tubes into a non-metallic header, wherein the method includes the steps of providing a predetermined plurality of tubes having a predetermined end configuration, and a non-metallic header having a predetermined number of openings corresponding to the predetermined plurality of tubes. The predetermined plurality of openings, disposed in the non-metallic header in a predetermined array, have a predetermined configuration substantially identical to the predetermined end configuration of the predetermined plurality of tubes. Finally the method includes the step of securing an end of each of the predetermined plurality of tubes into a respective predetermined plurality of openings in the non-metallic header.

### CROSS-REFERENCE TO RELATED APPLICATIONS

This application claims the benefit of U.S. Provisional Application No. 60/392,994 filed Jun. 28, 2002.

### FIELD OF THE INVENTION

The present invention generally relates to, but is not limited to, radiators, shell and tube type heat exchangers, charge air coolers, oil coolers, and fuel coolers. More particularly, the invention relates to non-metallic header joints.

### BACKGROUND OF THE INVENTION

Presently, heat exchangers are made using a plurality of tubes that are secured to a predetermined metallic header. Usually, such headers are produced from steel and brass tubes are mechanically rolled into the steel header. These steel headers are heavy, limited in shape, and costly to procure. The prior art has been pull tested with various techniques for producing the header hole, such as drill and ream, serrating, and in various roughness.

Prior to the instant invention, the “pull test” has been a standard method of evaluating the tube/header joint. It involves a tube inserted through a piece of header, and connected by solder or rolling operations to simulate manufacturing processes. In some cases actual cores are cut and in some cases special small sections were assembled. One problem with pull tests is sample alignment, if the sample is not straight, bending can cause non-uniform stress, thus higher stress usually at one nose of the tube. This was mentioned in several reports on soldered joints. This would lower the pull strength. There are some differences between soldered joints and rolled joints and will be discussed later.

Solder pull tests discussed below are at various conditions and several solder compositions including leaded and no-lead solder results. Note that the solder bond pull strength at operating conditions, 200F temperature and long term vibration, should be derated by 30+(25+10)=65%.

In the past it has been traditional practice to build cores with solder buildup on the outer rows, thus from data below the best estimate of soldered pull strength is:

0.008″ wall tubes, 0.040 flange header with lead/tin solder buildup 850 lbs derate 65%=552 lbs

Thus for this product line of Medium size radiator 10 to 40 square feet (up to 7 foot long tubes) The required pull strength of the joints should be above 500 lbs. Tests with various thinner header and 0.012″ wall tubes have been in this range and some times below. For example,

0.507″ CD, 0.0012″ wall tubes, 0.500″ Header: Avg 525 lbs.

0.507″ CD, 0.0012′ wall tubes, 0.375″ Header: Avg 490

0.250″ CD, 0.0017″ wall tubes, 0.060″ flanged header: Avg 350, one at 540 lbs.

As in known in the art in order to maximize Rolled Strength certain conditions apply, such as:

A) Hole Surface Roughness: 125- 250 u Finish

If too rough then hard to get air tight seal

B) Serrations: On Water Side (On Air Side Can Cause Tube Failures)

Some testing at 0.0075 and at 0.180″ deep. It is believed that minimum is better, because effects of surface roughness at 125 u-in. In one embodiment it may be desirable to sandblast.

C) Depth of Roll Maximized without Ever Going Beyond Header Depth.

Rolling below header can cause tube deformation and stress risers at highest stress points.

D) Hole Size: Small (Minimize Tube Deformation)

The less elongation, the more durable the joint, less initial damage

E) Wall Reduction: 11% on 0.018″ Wall Tubes.

Gives good strength, with minimum lamination of tube

F) Minimize Torching to Have Stronger Tube Material:

Torching may be desirable for expanding operation, There may not be a need to remove solder, if uniform and clean. Especially if serrations are used.

G) Clean Joint,

Clean header after drilling or initial manufacturing, and do not get lubricants in joints (inside header or outside of tube) from torching, expanding, sizing, rolling—Biggest problem times are sizing and scarfing where the tool extends over the outside of the tube. Several water-based lubricants may be used.

H) Remove Solder,

Most importantly solder on outside must be free of lumps or bumps that cause problems during rolling. This may not be required if solder is uniform and clean.

I) Fin Bond

Must have fin bond especially with 0.008″ wall tubes, otherwise vibration failures may occur when 2-3″ of a tube are not bonded. This allows the tube side to flex and causes stresses at the nose or weld seam of the tubes.

Outside rows must have fin bond, they have little support from fins.

Additionally, in prior art metallic headers there may be certain conditions where optional ream or serrations may be required or desirable. For example, some stiffening on the outer columns to prevent the header from flexing during vibration testing of 0.060″ header without buildup.

Stiffening could be small bumps in areas between tubes that extend beyond the tube to force header bending outside the first tube.

In pull tests for soldered tubes, a header section of about 2.5″ square by standard thickness and standard material is soldered to one “standard” tube. Sometimes a tube and header section is cut from a core. This tube is then put through a plate with a corresponding oval hole to add additional support to the header plate and to test just the tube/header joint and not the stiffness of the header. A grip then grabs the outside bottom of the tube and pulls down. Also in most cases the tube has a steel insert of the approximate inside thickness 0.090 which is soldered to the tube, this adds rigidity to eliminate tube failures. In most cases the insert was up to or beyond the tube/header joint, again to measure the soldered tube/header strength.

In pull tests for flat round tubes, a header: section of about 2.5″ square of desired thickness and material is mechanically bonded to one desired tube. Usually the sample is cut from a core. This tube has a steel insert, but is NOT soldered in place, and then a grip grabs the outside bottom of the tube and pulls down. Headers have traditionally been ⅝ Steel stocks, so very stiff, no additional stiffness is required to perform the test.

Tests indicate Temperature can have a large effect on solder shear strength. For example from 70 to 200 F, lead/Tin solder would lose 30% shear strength. It is doubtful that the mechanical bond pull strength of the joint would decrease. For yield, pull test data is reported as Maximum Load.

Failure data on solder joints; some reports included a “yield” which is 20-30% below maximum load. This becomes important in “Fatigue” or cyclic loading of cores, which most cores will seed due to thermal or mechanical changes. Thus the joint strength is less than the Maximum load from a pull strength.

No-lead solders are significantly stronger, as evidenced by the higher pull strengths, in many cases the tubes would break, not the solder joint.

The mechanical bond pull strength, is a friction fit and should not be affected by a yield except if the strength is near the tube yield, which would be effect both solder and mechanical the same.

For soldered joints there is also a fatigue limit, (for million cycles) and it is lower than the Yield Limit, typically, 5-15% below the yield.

As header gets thinner, they are less stiff and will allow more movement of header at outer rows and columns of tubes. Consider a vibration test, 1999, of no-lead solder without solder buildup in tube/header joints on showed the joint did not fail but the end columns of tubes failed earlier than the tubes with leaded solder and 0.275″ leaded solder buildup, due to additional displacement allowed by a weaker header without the solder buildup.

Soldered Joints: 0.006 and 0.008 Wall Tubes

In the following table, no reinforcement bars are present inside the tube during Pull test. 25/75 Tin Lead Solder, Yellow Brass Dimpled tubes,

| Tube | | .040 | .060 | .090 | .125 |
|---|---|---|---|---|---|
| Wall | Joint | Flng | Flng | Clean | Clean |
| .0058 | Solder | 410 lbs | 639 | 563 | 630 |
| | dip only | | | | |
| .0079 | Solder | 497 | 798 | 671 | 739 |
| | dip only | | | | |
| .0079 | Solder | 869 | 883 | | 852 |
| | dip with | | | | |
| | reinforce | | | | |
| .0079 | Solder | 870 | 878 | | 872 |
| | dip with | | | | |
| | buildup | | | | |

0.008″ Yellow brass lock-seam tubes in 0.040 Yellow brass header holes with flange samples used. 0.090″ soldered in strips inside tube reinforcement

| | Cville | Lexington |
|---|---|---|
| 25/75 Tin/Lead | 620 lbs | 727 |
| Topper NO-LEAD | 875 | 829 |

Soldered Joints: .016 to .018″ Wall Tubes

0.017″ Red brass tubes in 0.125 punched Yellow brass header, Standard 75/25% Lead tin solder.

| | | | Header + |
|---|---|---|---|
| | .156 | Header + Tube | Tube & Header |
| | Header | Reinforce | Reinforce |
| 65/35 lead/tin solder | 735 | | |
| 2.5 tin, .5 silver | 1060 | | 1605 |
| Tin/Silver + .093 bld | 1295 | | 1993 |
| Tin/Silver + .187 bld | | 1900 | |
| Tin/Silver = .375 bld | 2420 | | |

Most Testing Done at Ambient Temperature

At 200F, 5/50 Lead tin loses 1400/4600 Ratio (30%) of shear strength. (Handy & Hartman Test Data)

0.0171″ Red brass tubes in 0.156 punched Yellow brass header (NO LEAD Solder) J W Harris “NICK” Solder, 95% Sn, 2% Ag and 0.090 Tinned strips Inside tube reinforcement

AVERAGE 1288 lbs., Yield (790 lbs)

0.017″ Red brass tubes in 0.156 punched Yellow brass header, (NO LEAD Solder) J W Harris “NICK” Solder, Ni, AG, Sn, CU and 0.090″ Tinned strips inside tube reinforcement Tubes had flared ends. AVERAGE 1178 lbs Yield (730 lbs) 0.018″ Red brass Redrawn tubes in 0.156 punched Yellow brass header, (NO LEAD Solder) Staybrite and Bridgit

Some with 0.156 header reinforcement tig welded below header during pull test. Some samples used 0.090″ Tinned strips inside tube reinforcement.

| | | .156 Header + | .156 Header + Tube + |
|---|---|---|---|
| | .156 Header | Tube Reinforce | Header Reinforce |
| Stay Brite | 1166, y (690) | | |
| Stay Brite 8 | 1137 | 1138 | 1230, y (740) |
| Bridgit | 1230 | 1275 | 1255, y (773) |

Rolled Comparison:

Header 16 gage CRS (0.059″ thick) with a FLANGE. 0.0171″ Red brass, 0.25″ outer Diameter.

Round Connection:

| Rolled | Solder | |
|---|---|---|
| 330 | 470 | |
| 340 | 460 | |
| 360 | 460 | |
| 340 | 460 | |
| 343 | 463 | Excluding last point. |
| 540 | 540 | Rolled had a pronounce ridge, solder had longer |
| | | joint length than others. |

As can be seen from the above discussion, prior art metallic headers present a real problem which prior to the present invention has not been overcome.

### SUMMARY OF THE INVENTION

The present invention provides a method of reducing weight when securing a predetermined plurality of tubes into a non-metallic header, wherein the method includes the steps of providing a predetermined plurality of tubes having a predetermined end configuration, and a non-metallic header having a predetermined number of openings corresponding to the predetermined plurality of tubes. The predetermined plurality of openings, disposed in the non-metallic header in a predetermined array, have a predetermined configuration substantially identical to the predetermined end configuration of the predetermined plurality of tubes. Finally the method includes the step of securing an end of each of the predetermined plurality of tubes into a respective predetermined plurality of openings in the non-metallic header.

### OBJECTS OF THE INVENTION

It is, therefore, a primary object of the present invention to provide a tube to header joint in a non metallic header which enables a significant reduction in the overall weight in any given heat exchanger assembly.

Another object of this invention is to provide a tube to header joint in a non-metallic header, which enables lower fuel cost.

Another object of this invention is to provide a tube to header joint in a non-metallic header, which enables greater speed.

Another object of this invention is to provide a tube to header joint in a non-metallic header, which allows for additional power.

Yet another object of this invention is to provide a tube to header joint in a non-metallic header, which is interchangeable with existing metallic headers for retrofitting.

Yet another object of this invention is to provide a tube to header joint in a non-metallic header, which enables producing an unlimited amount of header shapes in any predetermined amount of envelope space.

Still another object of this invention is to provide a tube to header joint in a non-metallic header, which substantially reduces the material cost since metallic headers that are made from conventional material such as steel are significantly more expensive to procure than non-metallic material such as nylon.

These and various other objects and advantages of this invention will become more readily apparent to those persons skilled in the art after a full reading of the following detailed description, particularly, when such description is read in conjunction with the attached drawings as described below and the appended claims.

### BRIEF DESCRIPTION OF THE TABLES

Table 1 is a record sheet containing the average pull strength of all rolled test blocks.

Table 2 is a record sheet containing the pull strength on a tube to header joint strength using 0.012 thousand tubes and a plastic header material.

Table 3 is a record sheet containing tube to header joint strength using 0.012 thousand tubes and a plastic header material.

Table 4 is a record sheet containing tube to header joint strength using 0.012 thousand tubes and a Kynal plastic header material.

Table 5 is a record sheet containing additional tube to header joint strength using 0.012 thousand tubes and a Kynal plastic header material.

Table 6 is a record sheet containing additional tube to header joint strength using 0.012 thousand tubes and a Kynal plastic header material.

### BRIEF DESCRIPTION OF THE PRESENTLY PREFERRED AND ALTERNATE EMBODIMENTS OF THE INVENTION

A method of reducing weight when securing a plurality of tubes into a non-metallic header, according to a presently preferred embodiment of this invention, includes the steps of providing a predetermined plurality of tubes having a predetermined end configuration, generally oblong in shape, and a non-metallic header having a predetermined number of openings corresponding to the predetermined plurality of tubes. The predetermined plurality of openings have a predetermined configuration substantially identical to the predetermined end configuration of the predetermined plurality of tubes. Wherein the predetermined plurality of openings are disposed in the non-metallic header in a predetermined array. Finally the method includes the step of securing an end of each of the predetermined plurality of tubes into a respective predetermined plurality of openings in the non-metallic header.

The non-metallic header is provided in a predetermined variety of shapes to be used in a predetermined envelope size. Wherein the non-metallic header is molded to fit into the predetermined envelope size. The non-metallic header is made from a plastic material. The plastic material is selected from a group consisting of Kynal, nylon, Kevlar, polyester, and phenolic resin, and preferably the non-metallic header is made from Kynal.

The method further includes securing an end of each of the predetermined plurality of tubes into the respective predetermined plurality of openings in the non-metallic header by at least one of a mechanical bond and a non-mechanical bond. Wherein the predetermined plurality of tubes, is at least two, and are generally oblong in shape along substantially an entire length thereof. The mechanical bond includes at least one of rolling and machining, where rolling is the preferred method. The non-mechanical bond includes at least one of welding, and adhesion. A secondary predetermined bonding agent, such as a chemical bond, may also be used.

The method may further include the additional steps of forming an annular groove in each of the respective predetermined plurality of openings in the non-metallic header. Then seating an end of each of the predetermined plurality of tubes in the annular groove by inserting an internal sizing tool to seat the end into the annular groove.

As can be seen from the following tables, the present invention provides a non-metallic header which is equal to or better than prior type metallic headers in critical parameters.

TABLE 1

| | | | | | Pull | Pull | Pull | Pull | Pull | Pull | Pull | Pull |
|---|---|---|---|---|---|---|---|---|---|---|---|---|
| Record | Block | Hole | | | Strength | Strength | Strength | Strength | Strength | Strength | Strength | Strength |
| Sheet | No. | Serrated | Locktight | Glycol | Avg./Lbs. | Avg./Lbs. | Avg./Lbs. | Avg./Lbs. | Avg./Lbs. | Avg./Lbs. | Avg./Lbs. | Avg./Lbs. |
| 1 | 1 To 6 | Yes | No | No | 216.670 | | | | | | | |
| 2 | 1 To 4 | Yes | No | No | 312.500 | | | | | | | |
| 3 | 1 To 4 | Yes | No | No | 62.500 | | | | | | | |
| 1 | 7 To 12 | No | No | No | | 185.830 | | | | | | |
| 2 | 7-9; 11-13 | No | No | No | | 140.000 | | | | | | |
| 2 | 5,6 | Yes | Yes | No | | | 600.000 | | | | | |
| 3 | 5 To 8 | Yes | Yes | No | | | 681.250 | | | | | |
| 4 | 7,8,9 | Yes | Yes | No | | | 693.333 | | | | | |
| 2 | 10 | No | Yes | No | | | | 450 | | | | |
| 4 | 1 To 12 | Yes | Yes | Yes | | | | | 667.222 | | | |
| 4 | 9 To 18 | Yes | No | Yes | | | | | | 204.167 | | |
| 4 | 19 to 22 | No | Yes | Yes | | | | | | | 537.500 | |
| 4 | 23,24 | No | No | No | | | | | | | | 195.500 |
| AVG | | | | | 197.2233 | 162.9150 | 858.1943 | 450.0000 | 667.222 | 204.1670 | 537.5000 | 195.5000 |
| St. Dev. | | | | | 126.129 | 32.407 | 50.759 | | | | | |

TABLE 2

| | | Drilled | Reamed | | Header | Tube | | Round | Rolled | Rolled | Pull | Pull |
|---|---|---|---|---|---|---|---|---|---|---|---|---|
| Block | Header | Dia. @100 | Dia. | Reamer | Hole | Wall | Touching | Tube | Tube | Tube | Strength | Strength |
| No | Thickness | RPM Hdr. | Header | RPM | Serrated | Thickness | Color | I.D. | I.D. | Depth | Lbs | Lbs |
| 1 | 0.625 | 0.492 | 0.516 | 100 | YES | 0.012 | Cherry Red | 0.4780 | 0.4955 | 0.380 | 50 | |
| 2 | 0.625 | 0.481 | 0.518 | 170 | YES | 0.012 | Cherry Red | 0.4740 | 0,4965 | 0.810 | 250 | |
| 3 | 0.625 | 0.494 | 0.518 | 170 | YES | 0.012 | Cherry Red | 0.4740 | 0.4980 | 0.828 | 300 | |
| 4 | 0.625 | 0.491 | 0.516 | 140 | YES | 0.012 | Cherry Red | 0.4770 | 0.4970 | 0.810 | 380 | |
| 5 | 0.625 | 0.481 | 0.516 | 100 | YES | 0.012 | Cherry Red | 0.4750 | 0.4985 | 0.835 | 140 | |
| 6 | 0.625 | 0.493 | 0.518 | 200 | YES | 0.012 | Cherry Red | 0.4770 | 0.5000 | 0.819 | 200 | |
| 7 | 0.625 | 0.493 | 0.518 | 170 | NO | 0.012 | Cherry Red | 0.4750 | 0.4960 | 0.615 | | 50 |
| 8 | 0.625 | 0.495 | 0.518 | 170 | NO | 0.012 | Cherry Red | 0.4760 | 0.4945 | 0.648 | | 100 |
| 9 | 0.625 | 0.491 | 0.516 | 100 | NO | 0.012 | Cherry Red | 0.4780 | 0.4970 | 0.848 | | 180 |
| 10 | 0.625 | 0.492 | 0.516 | 100 | NO | 0.012 | Cherry Red | 0.4740 | 0.4985 | 0.632 | | 325 |
| 11 | 0.625 | 0.493 | 0.516 | 140 | NO | 0.012 | Cherry Red | 0.4750 | 0.4955 | 0.820 | | 240 |
| 12 | 0.625 | 0.494 | 0.519 | 200 | NO | 0.012 | Cherry Red | 0.4760 | 0.4990 | 0.625 | | 220 |
| AVG | | 0.4925 | 0.5171 | 146.6667 | | | | 0.4754 | 0.4970 | 0.6042 | 218.8887 | 185.8333 |
| St. Dev | | 0.0014 | 0.0012 | 38.9249 | | | | 0.0011 | 0.0016 | 0.0780 | 111.8332 | 99.3185 |

NOTES:
1. Header holes were chamfer on each side at 45° × 1/16 deep.
2. Before rolling tubes into the header blocks, they were cleaned in alcohol.
3. Header holes were drilled dry and rapid tap lubricant was used in the reaming process.
4. Young Radiator flat to round tooling was used in the rolling process.

TABLE 3

| | Header | | | | | | Tube | | | | |
|---|---|---|---|---|---|---|---|---|---|---|---|
| Block | | Drilled Dia. | Hole | I.D. Surface | Wall | Torching | Round | Rolled | Rolled | Strength | Strength |
| No | Thickness | 480 PRM | Serrated | Finish | Thickness | Color | I.D. | I.D. | Depth | Lbs | Lbs |
| 1 | 0.625 | 0.512 | YES | 1000+ | 0.012 | Cherry Red | 0.4760 | 0.4910 | 0.620 | 300 | |
| 2 | 0.625 | 0.512 | YES | 1000+ | 0.012 | Cherry Red | 0.4740 | 0.4900 | 0.610 | 300 | |
| 3 | 0.625 | 0.512 | YES | 1000+ | 0.012 | Cherry Red | 0.4750 | 0.4890 | 0.615 | 400 | |
| 4 | 0.625 | 0.512 | YES | 1000+ | 0.012 | Cherry Red | 0.4760 | 0.4890 | 0.648 | 250 | |
| 5 | 0.625 | 0.512 | YES | 1000+ | 0.012 | Cherry Red | 0.4760 | 0.4965 | 0.630 | 650 | |
| 6 | 0.625 | 0.512 | YES | 1000+ | 0.012 | Cherry Red | 0.4760 | 0.4865 | 0.630 | 550 | |
| 7 | 0.625 | 0.512 | NO | 90 | 0.012 | Cherry Red | 0.4740 | 0.4880 | 0.632 | | 50 |
| 8 | 0.625 | 0.512 | NO | 77 | 0.012 | Cherry Red | 0.4740 | 0.4980 | 0.626 | | 150 |
| 9 | 0.625 | 0.512 | NO | 82 | 0.012 | Cherry Red | 0.4750 | 0.4870 | 0.635 | | 175 |
| 10 | 0.625 | 0.512 | NO | 90 | 0.012 | Cherry Red | 0.4760 | 0.4960 | 0.625 | | 450 |
| 11 | 0.625 | 0.512 | NO | 82 | 0.012 | Cherry Red | 0.4755 | 0.4960 | 0.620 | | 125 |
| 12 | 0.625 | 0.512 | NO | 77 | 0.012 | Cherry Red | 0.4760 | 0.4970 | 0.630 | | 140 |
| 13 | 0.625 | 0.512 | NO | 77 | 0.012 | Cherry Red | 0.4760 | 0.4880 | 0.648 | | 200 |
| AVG | | | | | | | 0.4753 | 0.4925 | 0.6285 | 408.3333 | 184.2857 |
| St. Dev | | | | | | | 0.0009 | 0.0042 | 0.0112 | 159.4261 | 128.2415 |

NOTES:
1. Before rolling lube. into the header blocks, they we cleaned in alcohol.
2. Header holes we not reamed.
3. Header holes were drilled dry and with a 33/64 Dia.
4. Young Radiator flat to round tooling was used in the rolling process.
5. Blocks No. 5, 6, 10, Locktight was applied before rolling.
6. Block No. 6 and 12 were rolled with a rolling gun, all other blocks were rolled by hand.

TABLE 4

| | Header | Drilled | | | | I.D. | Tube | | | | | Pull | Pull |
|---|---|---|---|---|---|---|---|---|---|---|---|---|---|
| Block | Thick- | Dia. | Reamed | Reamer | Hole | Surface | Wall | Torching | Round | Rolled | Rolled | Strength | Strength |
| No | ness | 250 RPM | Dia. | RPM | Serrated | Finish | Thickness | Color | I.D. | I.D. | Depth | Lbs | Lbs |
| 1 | 0.625 | 0.512 | 0.5175 | 150 | Yes | 828 | 0.012 | Light Red | 0.475 | 0.508 | 0.600 | 50 | |
| 2 | 0.625 | 0.512 | 0.5180 | 1560 | Yes | 763 | 0.012 | Light Red | 0.474 | 0.508 | 0.600 | 75 | |
| 3 | 0.625 | 0.512 | 0.5195 | 150 | Yes | 819 | 0.012 | Light Red | 0.476 | 0.509 | 0.600 | 75 | |
| 4 | 0.625 | 0.512 | 0.5175 | 150 | Yes | 1046 | 0.012 | Light Red | 0.476 | 0.509 | 0.600 | 50 | |
| 5 | 0.625 | 0.512 | 0.5185 | 150 | Yes | 1163 | 0.012 | Light Red | 0.475 | 0.507 | 0.600 | | 650 |
| 6 | 0.625 | 0.512 | 0.5190 | 150 | Yes | 879 | 0.012 | Light Red | 0.478 | 0.508 | 0.600 | | 575 |
| 7 | 0.625 | 0.512 | 0.5195 | 150 | Yes | 746 | 0.012 | Light Red | 0.474 | 0.507 | 0.600 | | 750 |
| 8 | 0.625 | 0.512 | 0.5180 | 150 | Yes | 925 | 0.012 | Light Red | 0.475 | 0.507 | 0.600 | | 750 |
| AVG | | | 0.5184 | 326.2500 | | 896.1250 | 0.012 | | 0.4751 | 0.5079 | 0.6000 | 82.5000 | 681.2500 |
| St. Dev | | | 0.0008 | 498.5103 | | 144.2522 | 0.0000 | | 0.0008 | 0.0008 | 0.0000 | 14.4338 | 65.0957 |

NOTES:
1. Before rolling tubes into the header blocks, they were cleaned in alcohol.
2. Header holes were reamed.
3. Blocks No. 5, 6, 7, 8, Locktight was applied before rolling.
4. Young Radiator flat to round tooling was used in the rolling process.
5. All block were rolled with a rolling gun for .012 tubes.
6. Blocks No. 7, 8, Locktight held and the tubes were torn apart.
7. Blocks No. 10, 11, were drilled with 13 mm drill and not reamed.

TABLE 5

| | Header | Drilled | | | | I.D. | Tube | | | | | Pull | Pull |
|---|---|---|---|---|---|---|---|---|---|---|---|---|---|
| Block | Thick- | Dia. | Reamed | Reamer | Hole | Surface | Wall | Torching | Round | Rolled | Rolled | Strength | Strength |
| No | ness | 250 RPM | Dia. | RPM | Serrated | Finish | Thickness | Color | I.D. | I.D. | Depth | Lbs | Lbs |
| 1 | 0.625 | 0.512 | 0.5175 | 150 | Yes | 828 | 0.012 | Light Red | 0.475 | 0.508 | 0.600 | 50 | |
| 2 | 0.625 | 0.512 | 0.5180 | 1560 | Yes | 763 | 0.012 | Light Red | 0.474 | 0.508 | 0.600 | 75 | |
| 3 | 0.625 | 0.512 | 0.5195 | 150 | Yes | 819 | 0.012 | Light Red | 0.476 | 0.509 | 0.600 | 75 | |
| 4 | 0.625 | 0.512 | 0.5175 | 150 | Yes | 1046 | 0.012 | Light Red | 0.476 | 0.509 | 0.600 | 50 | |
| 5 | 0.625 | 0.512 | 0.5185 | 150 | Yes | 1163 | 0.012 | Light Red | 0.475 | 0.507 | 0.600 | | 650 |
| 6 | 0.625 | 0.512 | 0.5190 | 150 | Yes | 879 | 0.012 | Light Red | 0.478 | 0.508 | 0.600 | | 575 |
| 7 | 0.625 | 0.512 | 0.5195 | 150 | Yes | 746 | 0.012 | Light Red | 0.474 | 0.507 | 0.600 | | 750 |
| 8 | 0.625 | 0.512 | 0.5180 | 150 | Yes | 925 | 0.012 | Light Red | 0.475 | 0.507 | 0.600 | | 750 |
| AVG | | | 0.5184 | 326.2500 | | 896.1250 | 0.012 | | 0.4751 | 0.5079 | 0.6000 | 82.5000 | 681.2500 |
| St. Dev | | | 0.0008 | 498.5103 | | 144.2522 | 0.0000 | | 0.0008 | 0.0008 | 0.0000 | 14.4338 | 65.0957 |

NOTES:
1. Before rolling tubes into the header blocks, they were cleaned in alcohol.
2. Header holes were reamed.
3. Blocks No. 5, 6, 7, 8, Locktight was applied before rolling.
4. Young Radiator flat to round tooling was used in the rolling process.
5. All block were rolled with a rolling gun for .012 tubes.
6. Blocks No. 7, 8, Locktight held and the tubes were torn apart.
7. Blocks No. 10, 11, were drilled with 13 mm drill and not reamed.

TABLE 6

| | Header | | | | | | Tube | | | | | | |
|---|---|---|---|---|---|---|---|---|---|---|---|---|---|
| | Header | Drilled | | | | I.D. | Wall | | | | | Pull | Pull |
| Block | Thick- | Dia. | Reamed | Reamer | Hole | Surface | Thick- | Torching | Round | Rolled | Rolled | Strength | Strength |
| No | ness | 250 RPM | Dia. | RPM | Serrated | Finish | ness | Color | I.D. | I.D. | Depth | Lbs | Lbs |
| 1 | 0.625 | 0.512 | 0.5175 | 150 | Yes | 828 | 0.012 | Light Red | 0.475 | 0.508 | 0.600 | 50 | |
| 2 | 0.625 | 0.512 | 0.5180 | 1560 | Yes | 763 | 0.012 | Light Red | 0.474 | 0.508 | 0.600 | 75 | |
| 3 | 0.625 | 0.512 | 0.5195 | 150 | Yes | 819 | 0.012 | Light Red | 0.476 | 0.509 | 0.600 | 75 | |
| 4 | 0.625 | 0.512 | 0.5175 | 150 | Yes | 1046 | 0.012 | Light Red | 0.476 | 0.509 | 0.600 | 50 | |
| 5 | 0.625 | 0.512 | 0.5185 | 150 | Yes | 1163 | 0.012 | Light Red | 0.475 | 0.507 | 0.600 | | 650 |
| 6 | 0.625 | 0.512 | 0.5190 | 150 | Yes | 879 | 0.012 | Light Red | 0.478 | 0.508 | 0.600 | | 575 |
| 7 | 0.625 | 0.512 | 0.5195 | 150 | Yes | 746 | 0.012 | Light Red | 0.474 | 0.507 | 0.600 | | 750 |
| 8 | 0.625 | 0.512 | 0.5180 | 150 | Yes | 925 | 0.012 | Light Red | 0.475 | 0.507 | 0.600 | | 750 |
| 9 | 1 | | | | | | | | | | | | |
| 10 | 0.625 | 0.512 | | | No | 553 | 0.012 | Light Red | 0.479 | 0.509 | 0.600 | 50 | |
| 11 | 0.625 | 0.512 | | | Yes | 1100+ | 0.012 | Light Red | 0.479 | 0.509 | 0.600 | 50 | |
| AVG | #NULL! | 0.5120 | 0.5184 | 326.25 | | 896.125 | 0.012 | | 0.4915 | 0.5079 | 0.6000 | 63 | 681 |
| | ## | | | | | | | | | | | | |
| St. Dev | #NULL! | 0.0000 | 0.0007 | 488.31367 | | 905.857 | 0.000 | | 0.001 | 0.001 | 0.0000 | 13 | 74 |
| | ## | | | | | | | | | | | | |

NOTES:
1. Before rolling tubes into the header blocks, they were cleaned in alcohol.
2. Header holes were reamed.
3. Blocks No. 5, 6, 7, 8, Locktight was applied before rolling.
4. Young Radiator flat to round tooling was used in the rolling process.
5. All block were rolled with a rolling gun for .012 tubes.
6. Blocks No. 7, 8, Locktight held and the tubes were torn apart.
7. Blocks No. 10, 11, were drilled with 13 mm drill and not reamed.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A method of reducing weight when securing a plurality of tubes into a non-metallic header, said method comprising the steps of:
a) providing a predetermined plurality of tubes having a predetermined end configuration;
b) providing a non-metallic header having a predetermined number of openings corresponding to said predetermined plurality of tubes, said predetermined plurality of openings having a predetermined configuration substantially identical to said predetermined end configuration of said predetermined plurality of tubes, said predetermined plurality of openings being disposed in said non-metallic header in a predetermined array, and
c) securing an end of each of said predetermined plurality of tubes into a respective predetermined plurality of openings in said non-metallic header.

2. A method, according to claim 1, wherein said method includes the additional step of providing said non-metallic header in a predetermined variety of shapes.

3. A method, according to claim 1, wherein said method includes the additional step of providing a predetermined envelope size for said non-metallic header.

4. A method, according to claim 3, wherein said method includes the additional step of providing said non-metallic header molded to fit into said predetermined envelope size.

5. A method, according to claim 4, wherein said non-metallic header provided in step (b) is made from a plastic material.

6. A method, according to claim 5, wherein said plastic material is selected from a group consisting of Kynal, nylon, Kevlar, polyester, and phenolic resin.

7. A method, according to claim 6, wherein said plastic material is Kynal.

8. A method, according to claim 1, wherein said predetermined end configuration provided in step (a) is generally oblong in shape.

9. A method, according to claim 1, wherein said predetermined plurality of tubes provided in step (a) are generally oblong in shape along substantially an entire length thereof.

10. A method, according to claim 1, wherein step (c) further includes securing said end of each of said predetermined plurality of tubes into said respective predetermined plurality of openings in said non-metallic header by at least one of mechanical bonding and non-mechanical bonding.

11. A method, according to claim 10, wherein said mechanical bonding includes at least one of rolling and machining.

12. A method, according to claim 11, wherein said non-mechanical bonding includes at least one of welding, and adhesion.

13. A method, according to claim 12, wherein said mechanical bonding is preferably a rolling process.

14. A method, according to claim 1, wherein said step (c) further includes adding a secondary predetermined bonding agent.

15. A method, according to claim 14, wherein said secondary bonding agent is a chemical bond.

16. A method, according to claim 1, wherein said predetermined plurality of tubes is at least two.

17. A method, according to claim 1, wherein step (c) further includes the additional step of forming an annular groove in each of said respective predetermined plurality of openings in said non-metallic header.

18. A method, according to claim 17, wherein step (c) further includes seating said end of each of said predetermined plurality of tubes in said annular groove.

19. A method, according to claim 18, wherein seating said end of each of said predetermined plurality of tubes in step (c) includes the additional step of inserting an internal sizing tool.
